(19) United States
(12) Patent Application Publication
(10) Pub. No.: US 2009/0075626 A1
(43) Pub. Date: Mar. 19, 2009

(54) METHOD, SYSTEM AND APPARATUS OF CHARGING FOR GROUP MODE SERVICE

(75) Inventor: Mingjun SHAN, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/254,127

(22) Filed: Oct. 20, 2008

Related U.S. Application Data
(63) Continuation of application No. PCT/CN2007/000680, filed on Mar. 2, 2007.

(30) Foreign Application Priority Data
Apr. 20, 2006 (CN) 200610075940.2

(51) Int. Cl. H04M 11/00

(52) U.S. Cl. 455/406

(57) ABSTRACT

An charging method for group mode service relating to the group mode service in communication networks is disclosed, the method includes: sending, an initial accounting request to a charging system in response to receiving a service request for establishing a group session from a client, to enable the charging system account at an initial rate; and initiating an interim accounting request to the charging system to enable the charging system account at a rate corresponding to the current group scale in response to detecting that group scale is changed according to a preset threshold for the number of group users. The present invention also provides the corresponding application server, charging apparatus and group mode service's underlying system. By using the present invention to charge the group mode service, the charging interaction between the application server and the charging system is substantially reduced, and the network system resource consumed is reduced.

### CROSS-REFERENCE TO RELATED APPLICATIONS

This application is a continuation of International Patent Application No. PCT/CN2007/000680, filed Mar. 2, 2007, which claims priority to Chinese Patent Application No. 200610075940.2, filed Apr. 20, 2006, both of which are hereby incorporated by reference in their entirety.

### FIELD OF THE INVENTION

The present invention relates to group mode services in a communication network, and in particular, to a method of accounting for a group mode service, corresponding application server and charging system, and system for realizing a group mode service.

### BACKGROUND OF THE INVENTION

Group mode services include various services of different types, such as Instant Message (IM), Presence, Push to Talk over Cellular (PoC) and the like. Group mode services have a common characteristic, that is, after a session initiator initiates a session, all users belonging to the same group may select to participate in the session, and users who have participated in the session may also select to exit the session. In other words, in a group mode service, the number of users participating in a session is variable.

Taking a PoC service for example, it is a Push-to-talk service employing VoIP technology based on a mobile cellular public network. After a PoC user sets a group list, the user may have a point-to-point semi-duplex conversation with other PoC users or have a point-to-multipoint semi-duplex conversation with users in a group that is preset, by only pressing a dedicated key. FIG. 1 shows a schematic diagram of point-to-multipoint communication in a PoC service.

A PoC server plays in a PoC service a role of realizing application layer network functions, including controlling PoC function and participating PoC function.

FIG. 2 is a structural diagram when a PoC Server in which controlling PoC function exists and a PoC Server in which participating PoC function exists belong to different networks. In a point-to-point PoC session and an Ad-hoc PoC session, a PoC Server that acts as an inviting party performs controlling PoC function; while in a PoC chat group and a Pre-arranged group session, a PoC Server that has group identification (ID) performs controlling PoC function. For point-to-multipoint PoC communication, if there are N participants in a PoC session, there will be N interacting paths for transmitting media and signaling when a PoC Server performs controlling PoC function.

During accounting for a PoC service, accounting factors of a session service mainly include the following:

PoC session type, such as Ad-hoc, Pre-arranged and Chat PoC;

the number of participations in a group of the PoC session, or the number of recipients of a Talk Burst;

service network ID; and

applying time of the PoC Service, etc.

At present, in accounting solutions of the prior art, for example, in an Ad-hoc accounting solution or a Pre-arranged accounting solution, accounting is performed on a session owner or a session participant. When accounting is performed on a session owner, it is usually started by a PoC Server in which controlling PoC function exists; whereas when accounting is performed on a session participant, it is usually started by a PoC Server in which participating PoC function exists.

In the prior art, an accounting rate with respect to a session owner should be adjusted according to variation of the number of PoC participants; moreover, each time a PoC Server receives a SIP message (including an INVITE message and a BYE message), it triggers an ACcounting Request (ACR) to an charging system, and the charging system replies an ACcounting Answer (CCR) at the same time. In this way, when a lot of users participate in a session, a large amount of ACRs and CCRs should be delivered between the PoC Server and the charging system, and thereby consumption of system resources is very large.

### SUMMARY OF THE INVENTION

Embodiments of the invention provide a method of accounting for a group mode service, which can reduce accounting-related signaling transmitted between an application server and a charging system.

The embodiments of the invention further provide an application server, a charging system, and a system for realizing a group mode service.

A method of accounting for a group mode service includes the following steps:

initiating, by a client, a service request for establishing a group session to an application server; sending, by the application server, an initial accounting request to a charging system; and performing, by the charging system, accounting at an initial accounting rate; and

counting, by the application server, the number of online group users according to a received session joining/leaving request from a group user, determining that group scale is changed according to a preset variation threshold for the number of group users, and initiating an interim accounting request to the charging system; and performing, by the charging system, accounting at a rate corresponding to the current group scale.

An application server includes a group mode service functional unit, and further includes:

a group scale determining unit, adapted to determine the current group scale, according to the number of online users in a group;

a group scale change determining unit, adapted to determine whether the group scale is changed; and

an accounting requesting unit, adapted to send an initial accounting request to a charging system according to a service request for establishing a group session initiated by a client, and initiate an interim accounting request, which carries information on the number of online group users or group scale information, to the charging system after the group scale is changed.

A charging system includes:

an accounting request (ACR) receiving and resolving unit, adapted to receive an initial accounting request or interim accounting request initiated by an application server, and resolve information on the number of online group users or group scale information carried in the interim accounting request;

a rate determining unit adapted to determine an initial rate according to the initial accounting request, and determine a corresponding accounting rate according to the resolved information on the number of online group users or group scale information; and

a fee computing unit adapted to perform accounting at the determined initial rate or corresponding accounting rate.

A system for realizing a group mode service includes an application server and a charging system, in which the application server is adapted to realize a group mode service, send an initial accounting request to the charging system according to a service request for establishing a group session initiated by a client, determine the current group scale according to the number of online group users, and initiate an interim accounting request, which carries information on the number of online group users or group scale information, to the charging system when it is determined that the group scale is changed; and

the charging system is adapted to receive the initial accounting request or interim accounting request initiated by the group application server, resolve the information on the number of online group users or group scale information carried in the interim accounting request, determine an initial rate according to the initial accounting request, determine a corresponding accounting rate according to the resolved information on the number of online group users or group scale information, and perform accounting according to the determined initial rate or corresponding accounting rate.

According to the embodiments of the invention, an application server counts the number of users in the current online session, determines the current group scale according to the counted result, and triggers accounting only when the group scale is changed, thereby greatly reducing accounting signaling interacted between the application server and the charging system, and decreasing occupation of network system resources.

### BRIEF DESCRIPTION OF THE DRAWINGS

FIG. 1 is a schematic diagram illustrating a point-to-multipoint communication in a PoC service;

FIG. 2 is a structural diagram when a PoC Server in which controlling PoC function exists and a PoC Server in which participating PoC function exists belong to different networks;

FIG. 3 is a flow chart of a method of accounting for a group-type service, according to an embodiment of the invention;

FIG. 4 is a block diagram illustrating a process of accounting for a group-type service by taking a PoC service as an example, according to an embodiment of the invention;

FIG. 5 is a flow chart illustrating accounting signaling of a group-type service by taking a PoC service as an example, according to an embodiment of the invention;

FIGS. 6A-6F are flow charts illustrating signaling when an application server initiates an accounting request in different states by taking a PoC service as an example, according to an embodiment of the invention;

FIG. 7 is a schematic structural diagram of an application server, according to an embodiment of the invention; and

FIG. 8 is a schematic structural diagram of a charging system, according to an embodiment of the invention.

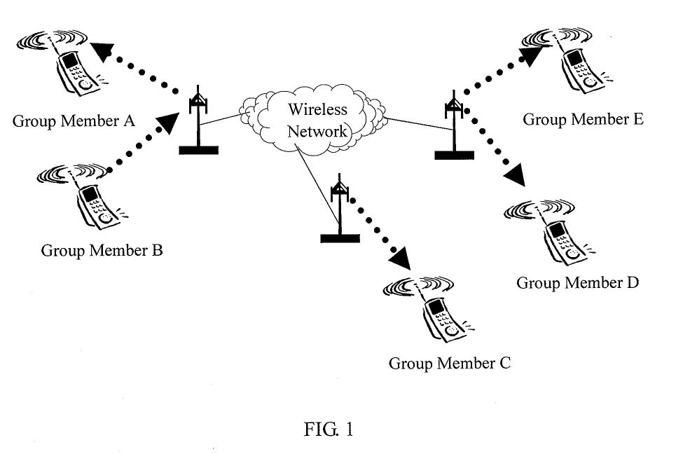

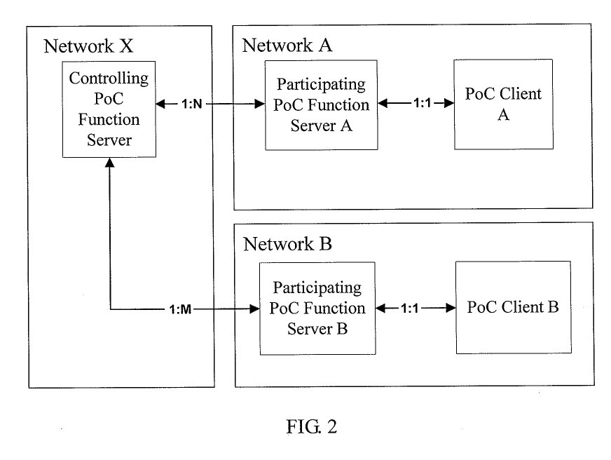

### DETAILED DESCRIPTION OF THE EMBODIMENTS

Embodiment of the present invention provides a method of accounting for a group mode service, which is as follows:

counting, by an application server, the number of users in the current online session after receiving a session joining or leaving request from a group user, detecting the current group scale according to the counted result, and determining whether the group scale is changed; and initiating an accounting request to a charging system if the group scale is changed; and performing, by the charging system, accounting at a rate corresponding to the number of users in the current online session or the current group scale after receiving the accounting request.

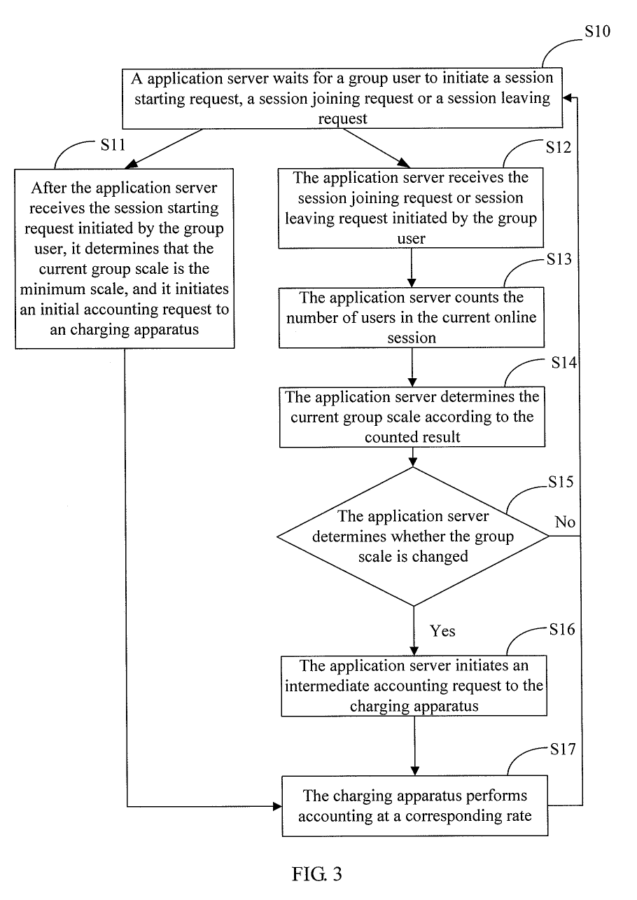

Referring to FIG. 3, it is a flow chart showing steps of the method according to an embodiment of the present invention. In the process shown in FIG. 3, before entering a normal session, the process includes the following: a client sends a group mode service request to an application server for requesting to establish a multi-party group session; the application server sends an initial accounting request to a charging system; the charging system returns an answer, which carries a triggering variable for a variation threshold for the number of users, to the application server, wherein the triggering variable meets a triggering condition, i.e. it is determined that the group scale is changed, when variation of the number of group users exceeds the variation threshold for the number of users, so that an interim accounting request is needed to be initiated to the charging system.

During the session, the application server monitors the triggering variable. Specifically, it includes the following steps.

At Step S10, the application server waits for a group user to initiate a session starting request, a session joining request, or a session leaving request.

At Step S11, after the application server receives the session starting request initiated by the group user, it determines that the current group scale is an initial scale, and initiates an initial accounting request to a charging system. Then, the process turns to Step S17.

At Step S12, the application server receives the session joining request or session leaving request initiated by the group user. Then, the process proceeds to Step S13.

At Step S13, the application server counts the number of users in the current online session. Then, the process proceeds to Step S14.

At Step S14, the application server determines the current group scale according to the counted result; in other words, it determines whether the triggering condition on the variation threshold for the number of users is met. Specifically, the process is as follows.

Corresponding relationship between group scales and ranges of the number of users delimited according to the variation threshold for the number of users is stored in advance in the application server. After the application server counts the number of group users in the current online session, it searches for the stored corresponding relationship and determines the current group scale. See the following Table 1.

TABLE 1

| Number Of Users | Group Scale |
|---|---|
| 0~5 | Scale1 |
| 6~15 | Scale2 |
| 16~40 | Scale3 |
| >40 | Scale4 |

In the Table 1, the following three variation thresholds for the number of users are set: a first threshold “5,” a second threshold “15,” and a third threshold “40.” The number of users is divided into four ranges.

In the Table 1, corresponding to the ranges of the number of users, there are totally four group scales, which are as follows:

a first group scale corresponds to a group scale ID “Scale1;”

a second group scale corresponds to a group scale ID “Scale2;”

a third group scale corresponds to a group scale ID “Scale3;” and

a fourth group scale corresponds to a group scale ID “Scale4.”

If the number of actual online users in the current session is less than or equal to the first threshold, it is determined that the current group scale is the “first group scale.”

If the number of actual online users in the current session is greater than the first threshold and less than or equal to the second threshold, it is determined that the current group scale is the “second group scale.”

If the number of actual online users in the current session is greater than the second threshold and less than or equal to the third threshold, it is determined that the current group scale is the “third group scale.”

If the number of actual online users in the current session is greater than the third threshold, it is determined that the current group scale is the “fourth group scale.”

It is supposed that the number of users counted currently is 8, because the number of users of 8 is greater than the first threshold and less than the second threshold, it is determined according to Table 1 that the current group scale is the second scale “Scale2.”

At Step S15, the application server further determines whether the group scale is changed; and if the group scale is not changed, the process turns to Step S10; while when the group scale is changed, the process turns to Step S16. Specifically, the process is as follows.

The application server determines whether the current group scale determined is the same as the latest group scale, and if they are the same, it is determined that the group scale is not changed; while if they are different, it is determined that the group scale is changed.

For example, it is supposed that the latest group scale is the second scale “Scale2.” If there are users exiting the session from time to time and the number of online users counted currently is 5, then it can be seen from Table 1 that the group scale determined currently shall be the first scale “Scale1,” that is to say, at this point, the group scale has been changed.

At Step S16, the application server initiates a new accounting request, i.e. an interim accounting request, to the charging system. Specifically:

1) when the application server initiates an interim accounting request to the charging system, the request carries information on the number of users; or

2) when the application server initiates an interim accounting request to the charging system, the request carries information on the current group scale determined.

At Step S17, the charging system performs accounting at a corresponding rate. Specifically:

if the charging system receives the initial accounting request, it performs accounting at the initial rate;

a first table of corresponding relationship and a second table of corresponding relationship are stored in the charging system;

corresponding relationship between the ranges of the number of users and the accounting rates is stored in first table of corresponding relationship;

corresponding relationship between the group scales and the accounting rates is stored in the second table of corresponding relationship;

after the charging system receives the interim accounting request carrying the information on the number of users, it searches the first table of corresponding relationship, determines the corresponding accounting rate by matching and performs accounting at the matched accounting rate; and

after the charging system receives the interim accounting request carrying the group scale information, it searches the second table of corresponding relationship, determines the corresponding accounting rate by matching, and performs accounting at the matched accounting rate.

The above processing will be repeated until the current session ends.

Accounting mode that may be employed by the charging system includes online accounting mode or offline accounting mode.

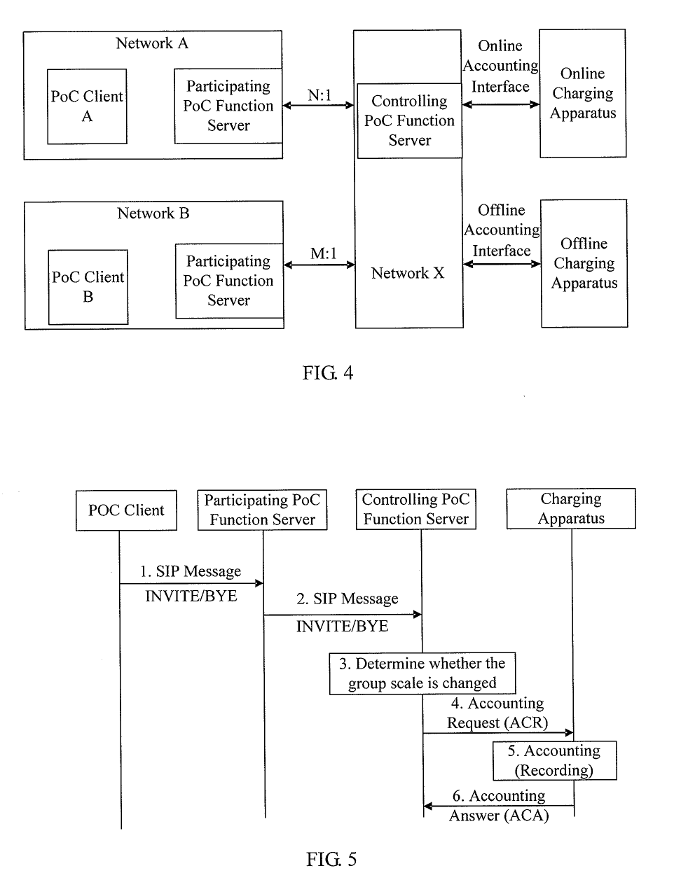

When the method of accounting according to an embodiment of the present invention is applied to a PoC service, a corresponding block diagram for performing accounting is shown in FIG. 4. It is supposed that, N users in a PoC group and their corresponding participating PoC function server lie in a network A, M users and their corresponding participating PoC function Server lie in a network B, and a controlling function server for the group lies in a network X; media and signaling are transmitted between the controlling function server for the group and the participating PoC function Server in the network A via N interacting paths; and media and signaling are transmitted between the controlling function server for the group and the participating PoC function Server in the network B via M interacting paths. The controlling function server for the group is connected with an online charging system via an online accounting interface, or it is connected with an offline charging system via an offline accounting interface.

the method of accounting according to an embodiment of the present invention is applied to PoC service, specific accounting signaling is shown in FIG. 5 and includes:

1) a PoC client sends a Session Initiated Protocol (SIP) message, which includes a SIP INVITE message or SIP BYE message, to a participating PoC function Server;

2) the participating PoC function Server forwards the SIP INVITE message or SIP BYE message to a controlling PoC function Server;

3) the controlling PoC function Server counts the number of users and determines whether group scale is changed; a specific determination method is shown by Step S14 and Step S15 in the flow chart shown in FIG. 3;

4) after the controlling PoC function Server determines that the group scale is changed, it initiates an accounting request (ACR), which carries information on the number of the current online users or information on the current group scale, to a charging system;

5) after the charging system receives the accounting request, it performs accounting at a corresponding accounting rate according to the number of the current users or the group scale, and records the result of accounting; and

6) the charging system returns an accounting answer (ACA) to the controlling PoC function Server.

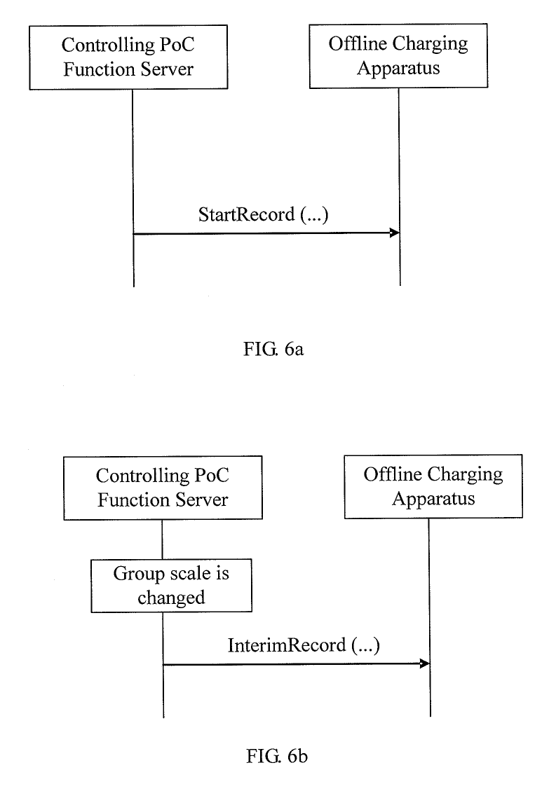

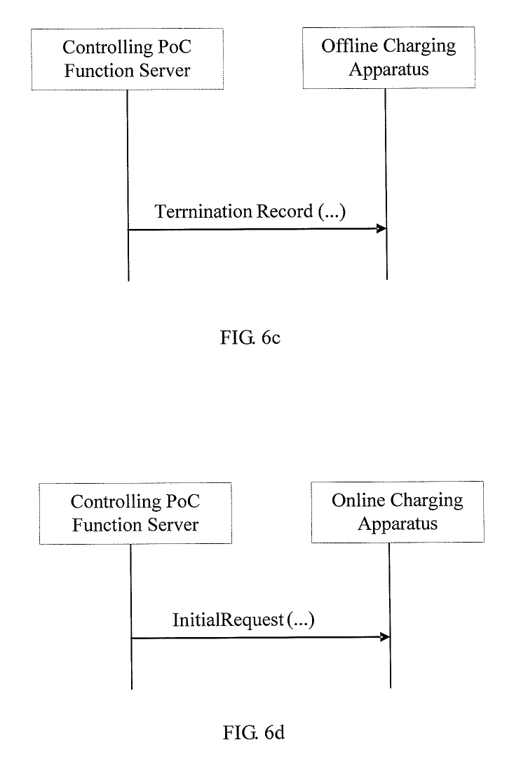

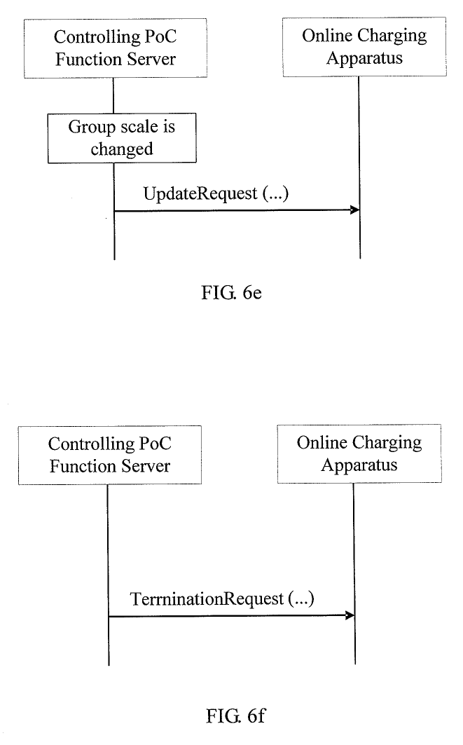

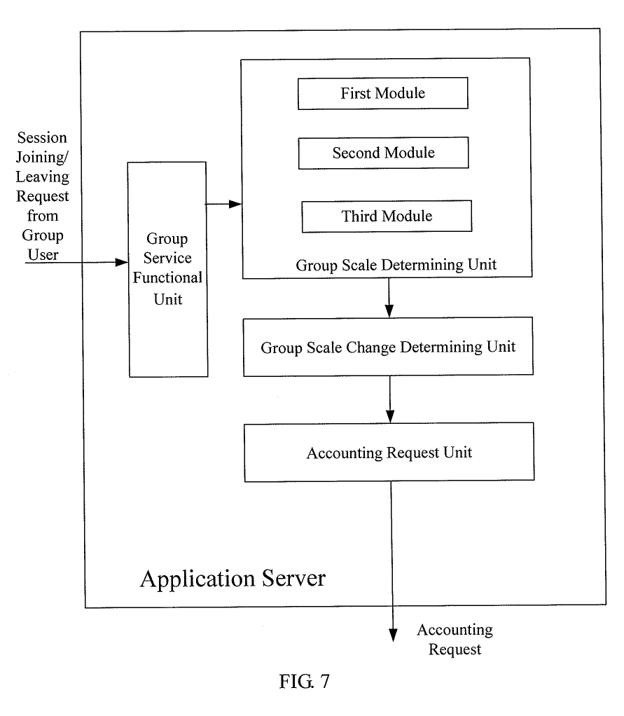

Specific situations in which the controlling PoC function Server initiates an accounting request to the charging system include the following six cases as shown in FIGS. 6A-6F.

When offline accounting mode is employed, the process in which the controlling PoC function Server triggers accounting is as follows.

1) When the controlling PoC function Server receives a session starting request initiated by a user, it initiates an initial accounting request to the offline charging system, as shown in FIG. 6A; this accounting request message is StartRecord, which may carry information on the number of users of “1,” or carry identification information of the minimum group scale, such as “Scale1.”

2) When a user joins or leaves the session, the controlling PoC function Server counts the number of the current users and determines whether the group scale is changed; when the group scale is changed, it initiates an interim accounting request to the offline charging system, as shown in FIG. 6B; this accounting request message is InterimRecord, which may carry information on the number of users, such as “8,” or carry identification information of the current group scale, such as “Scale2.”

3) When the session initiator ends the current session, the controlling PoC function Server initiates an accounting termination request to the offline charging system, as shown in FIG. 6C; this accounting request message is TerminationRecord.

When online accounting mode is employed, the process in which the controlling PoC function Server triggers accounting is as follows.

4) When the controlling PoC function Server receives a session starting request initiated by a user, it initiates an initial accounting request to the online charging system, as shown in FIG. 6D; this accounting request message is InitialRequest, which may carry information on the number of users of “1,” or carry identification information of the minimum group scale, such as “Scale1.”

5) When a user joins or leaves the session, the controlling PoC function Server counts the number of the current users and determines whether the group scale is changed; when the group scale is changed, it initiates an accounting update request to the online charging system, as shown in FIG. 6E; this accounting request message is UpdateRequest, which may carry information on the number of users, such as “8,” or identification information of the current group scale, such as “Scale2.”

6) When the session initiator ends the current session, the controlling PoC function Server initiates an accounting termination request to the online charging system, as shown in FIG. 6F; this accounting request message is TerminationRequest.

According to the above method of the embodiments of the invention, the invention provides an embodiment of a corresponding application server, of which a specific structure is shown in a schematic diagram of FIG. 7. The application server includes a group mode service functional unit for realizing a group mode service, and it further includes:

a group scale determining unit adapted to determine the current group scale according to the number of online users in a group;

a group scale change determining unit adapted to determine whether the group scale is changed; and

an accounting requesting unit adapted to send an initial accounting request to a charging system according to a service request for establishing a group session initiated by a client, and initiate an interim accounting request, which carries information on the number of online group users or group scale information, to the charging system after the group scale is changed.

The group scale determining unit includes:

a first module adapted to receive a session joining/leaving request from a group user;

a second module adapted to compute the number of online group users in the current session; and

a third module adapted to determine the current group scale according to the counted result.

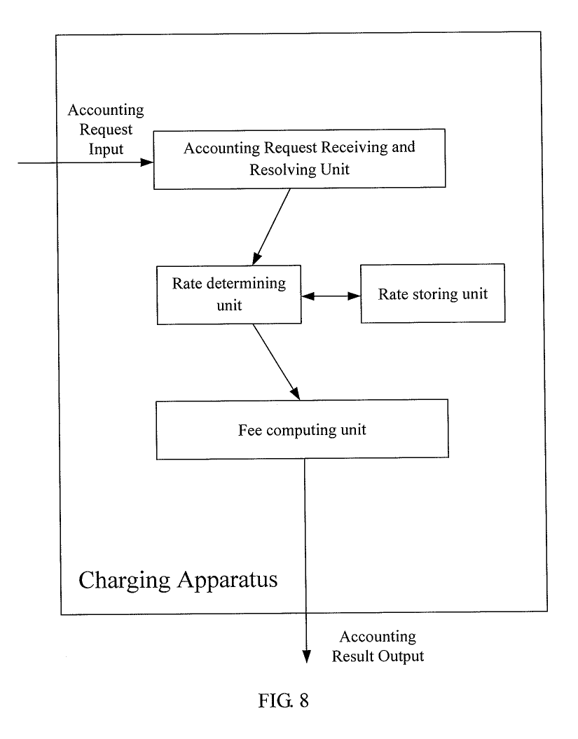

According to the embodiment of the above method of the invention, the invention provides an embodiment of a corresponding charging system, of which a specific structure is shown in FIG. 8. The charging system includes:

an accounting request receiving and resolving unit adapted to receive an initial accounting request and an interim accounting request initiated by an application server, and

resolve information on the number of online group users or group scale information carried in the interim accounting request;

a rate determining unit adapted to determine an initial rate according to the initial accounting request, and determine a corresponding accounting rate according to the resolved information on the number of online group users or group scale information; and

a fee computing unit adapted to perform accounting at the determined accounting rate.

The above charging system further includes a rate storing unit adapted to store a first table of corresponding relationship and a second table of corresponding relationship.

Corresponding relationship between range values of the number of users and accounting rates is stored in the first table of corresponding relationship.

Corresponding relationship between group scales and accounting rates is stored in the second table of corresponding relationship.

The rate determining unit searches the first table of corresponding relationship after it resolves the information on the number of online group users, or the rate determining unit searches the second table of corresponding relationship according to the resolved group scale information, then determines a corresponding accounting rate and notifies it to the fee computing unit; and the fee computing unit performs accounting at the determined accounting rate.

Additionally, the invention further provides a system for realizing a group mode service, which includes the above application server and charging system.

In conclusion, in the embodiments of the invention, an application server is used to compute the number of users in the current online session and determine the current group scale according to the counted result; accounting is triggered only when the group scale is changed. Therefore, accounting signaling interacted between the application server and the charging system may be reduced greatly, and occupation of network system resources may be decreased.

In the embodiments of the invention, accounting is performed at a corresponding rate according to the number of users that participate a session currently. Thus, practical service accounting requirements can be met better, thereby better promoting service consumption.

Various modifications and variations may be made by those skilled in the art without departing from the spirit and scope of the invention. Therefore, as long as such modifications and variations fall in within the scope of the claims of the invention or their equivalent, the invention is intended to cover these modifications and variations.

What is claimed is:

1. A method of charging for a group mode service, comprising:
sending an initial accounting request to a charging system in response to receiving a service request for establishing a group session from a client, to enable the charging system account at an initial rate; and
initiating an interim accounting request to the charging system to enable the charging system account at a rate corresponding to the current group scale in response to detecting that group scale is changed according to a preset threshold for the number of group users.

2. The method according to claim 1, further comprising:
receiving an answer carrying a triggering condition for the variation threshold for the number of users from the charging system,
wherein the detecting that group scale is changed according to a preset threshold for the number of group users comprises: detecting that variation of the number of group users exceeds the variation threshold for the number of users.

3. The method according to claim 1, further comprising:
delimiting, corresponding ranges of the number of users, according to the variation threshold for the number of users,
wherein the determining that the group scale is changed comprises: computing the number of online users in the current session; querying a corresponding relationship of the number of users which are delimited according to the variation threshold and the group scale; and determining that the group scale is changed according to the corresponding relationship.

4. The method according to claim 3, wherein the determining that the group scale is changed comprises:
determining two thresholds with the closest values after the computing the number of online group users in the current session;
delimiting a range of the number of users according to the two thresholds, and determining the current group scale according to the corresponding relationship; and
determining that the group scale is changed when the current group scale is different from the last group scale.

5. A method of charging for a group mode service, comprising:
accounting at an initial rate in response to receiving an initial accounting request from a application server; and
accounting at a rate corresponding to the current group scale in response to receiving an interim accounting request from the application server when the application server compute number of online users according to the session joining/leaving request from a user and detect that group scale is changed according to a preset threshold for the number of group users.

6. The method according to claim 5, wherein:
a corresponding relationship between group scales or ranges of the number of users and accounting rates is stored in advance in the charging system; the method further comprises:
searching for the corresponding relationship of the accounting rates, determines a corresponding accounting rate.

7. The method according to claim 1, wherein accounting mode employed by the charging system comprises online accounting mode or offline accounting mode.

8. An application server, comprising a group mode service functional unit, wherein the application server further comprises:
a group scale determining unit, adapted to determine a current group scale according to a number of online users in a group;
a group scale change determining unit, adapted to determine that the group scale is changed; and
an accounting requesting unit, adapted to send an initial accounting request to a charging system according to a service request for establishing a group session initiated by a client, and initiate an interim accounting request, which carries information on the number of online group users or group scale information, to the charging system after the group scale is changed.

9. The application server according to claim 8, wherein the group scale determining unit comprises:
a first module, adapted to receive a session joining/leaving request from a group user;
a second module, adapted to compute the number of online group users in the current session after the first module receives a session joining/leaving request from a group user; and
a third module, adapted to determine the current group scale according to a computed result.

10. A charging system, comprising:
an accounting request receiving and resolving unit, adapted to receive an initial accounting request or an interim accounting request initiated by an application server, and resolve information on the number of online group users or group scale information carried in the interim accounting request;
a rate determining unit, adapted to determine the initial rate according to the initial accounting request, and determine a corresponding accounting rate according to the resolved information on the number of online group users or group scale information; and
a fee computing unit, adapted to perform accounting at the determined initial rate or corresponding accounting rate.

11. The charging system according to claim 10, further comprising a rate storing unit adapted to store a first table of corresponding relationship and a second table of corresponding relationship, wherein:
corresponding relationship between range values of the number of users and accounting rates is stored in the first table of corresponding relationship;
corresponding relationship between group scales and accounting rates is stored in the second table of corresponding relationship; and
the rate determining unit searches the first table of corresponding relationship according to the resolved information on the number of online group users, or searches the second table of corresponding relationship according to the resolved group scale information, and determines the corresponding accounting rate.

12. A system for realizing a group mode service, comprising:
a application server, adapted to realize a group mode service, send an initial accounting request according to a service request for establishing a group session initiated by a client, determine the current group scale according to the number of online users in a group, and initiate an interim accounting request, which carries information on the number of online group users or group scale information, to the charging system when it is determined that the group scale is changed; and
a charging system, adapted to receive the initial accounting request or interim accounting request initiated by the group application server, resolve the information on the number of online group users or group scale information carried in the interim accounting request, determine an initial rate according to the initial accounting request, determine a corresponding accounting rate according to the resolved information on the number of online group users or group scale information, and perform accounting at the determined initial rate or corresponding accounting rate.
